(19) United States
(12) Patent Application Publication
(10) Pub. No.: US 2017/0221322 A1
(43) Pub. Date: Aug. 3, 2017

(54) SYSTEM AND METHOD OF MULTIMODAL STATUS INDICATION

(71) Applicant: Brian M. Ignomirello, Holmdel, NJ (US)

(72) Inventor: Brian M. Ignomirello, Holmdel, NJ (US)

(21) Appl. No.: 15/089,729

(22) Filed: Apr. 4, 2016

Related U.S. Application Data
(60) Provisional application No. 62/289,686, filed on Feb. 1, 2016.

(51) Int. Cl. G08B 5/38; F21V 3/04; H05B 33/08; F21V 5/04; H05B 37/02

(52) U.S. Cl. CPC G08B 5/38; F21V 5/04; H05B 37/0227; H05B 33/0845; H05B 33/0857; F21V 3/049; F21V 3/0445; F21Y 2101/02

(57) ABSTRACT

A multimodal status indicator, including a processor coupled to a memory; a sensor coupled to the processor, to provide a status of a monitored equipment; a central light source coupled to the processor; and a plurality of spoke light sources coupled to the processor, wherein the memory stores sets of programmed instructions that, when executed by the processor, drive an operating mode of the central light source and spoke light sources to indicate the status of the monitored equipment. A method to operate a multimodal status indicator, comprising the steps of sensing a status of a monitored equipment; determining a first operating mode of a central light source and a plurality of spoke light sources to indicate the sensed status of the monitored equipment; and controlling the central light source and the plurality of spoke light sources in accordance with the determined operating mode.

### CROSS-REFERENCE TO RELATED APPLICATIONS

This application claims the benefit of U.S. Provisional Application Ser. No. 62/289,686, filed on Feb. 1, 2016, the entire content of which is hereby incorporated by reference in its entirety.

### BACKGROUND

Field

Embodiments of the present disclosure generally relate to status indicators, and, in particular, to a system and method for multimode status indicators.

Description of Related Art

Light emitting diode (LED) status indicators are often used to indicate an operating status of an electronic device. Conventionally, each LED is dedicated to a single function (e.g., separate LEDs to indicate an on/off status, whether an individual data line currently is active, whether an error condition exists, etc.). LEDs are advantageous as a status indicator because, compared to competing technologies such as a liquid crystal display (LCD), each individual LED is small, inexpensive, highly visible, and simple to interface with driving electrical circuitry. However, as electronic devices become smaller, and as the number of functions that may need to be reported increases (e.g., various internal operating states of the electronic device), there is a shortage of space on the electronic device and/or internally for wiring to include the desired number of LEDs.

Therefore, a more space-efficient status indicator is needed, while maintaining the advantages of conventional LEDs.

### BRIEF SUMMARY

In one embodiment, a circuit module provides a multimodal LED display to indicate operating modes of a monitored electronic equipment.

In one embodiment, a method operates a multimodal LED display to indicate operating modes of a monitored electronic equipment.

An embodiment in accordance with the present disclosure provides a multimodal status indicator, including a processor coupled to a memory; a sensor coupled to the processor, to provide a status of a monitored equipment; a central light source coupled to the processor; and a plurality of spoke light sources coupled to the processor, wherein the memory stores sets of programmed instructions that, when executed by the processor, drive an operating mode of the central light source and spoke light sources to indicate the status of the monitored equipment.

An embodiment in accordance with the present disclosure provides a method to operate a multimodal status indicator, comprising the steps of sensing a status of a monitored equipment; determining a first operating mode of a central light source and a plurality of spoke light sources to indicate the sensed status of the monitored equipment; and controlling the central light source and the plurality of spoke light sources in accordance with the determined operating mode.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings wherein like reference numerals in the various figures are utilized to designate like components, and wherein:

FIG. 1A is an exploded perspective view of a circuit module in accordance with an embodiment of the present disclosure;

FIG. 1B is an overhead plan view of a circuit module in accordance with an embodiment of the present disclosure; and

FIG. 2 illustrates at a high level of abstraction a method, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

A module that performs a function also may be referred to as being configured to perform the function, e.g., a data module that receives data also may be described as being configured to receive data. Configuration to perform a function may include, for example: providing and executing computer code in a processor that performs the function; providing provisionable configuration parameters that control, limit, enable or disable capabilities of the module (e.g., setting a flag, setting permissions, setting threshold levels used at decision points, etc.); providing a physical connection, such as a jumper to select an option, or to enable/disable an option; attaching a physical communication link; enabling a wireless communication link; providing electrical circuitry that is designed to perform the function without use of a processor, such as by use of discrete components and/or non-CPU integrated circuits; energizing a circuit that performs the function (e.g., providing power to a transceiver circuit in order to receive data); and so forth.

As used herein, the term “transmitter” may generally comprise any device, circuit, or apparatus capable of transmitting a signal. As used herein, the term “receiver” may generally comprise any device, circuit, or apparatus capable of receiving a signal. As used herein, the term “transceiver” may generally comprise any device, circuit, or apparatus capable of transmitting and receiving a signal. As used herein, the term “signal” may include one or more of an electrical signal, a radio signal, an optical signal, an acoustic signal, and so forth.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes a computer readable signal medium such as a propagating signal. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A spectrum of colors can be formed from an additive combination of red, green and blue (RGB), e.g., when lighting a display, or a subtractive combination of magenta, yellow and cyan (sometimes approximated as red, yellow, blue), i.e., when mixing paints. For electronic purposes (e.g., electronic displays, computer-controlled displays, television, etc.), an RGB additive color model is usually used. Color depth, also known as bit depth, is either the number of bits used to indicate the color of a single pixel, e.g., in a bitmapped image or video frame buffer, or the number of bits used for each color component of a single pixel. For example, a 24-bit color depth may be formed by allocating eight bits to each color component of red, green and blue, resulting in 2⁸=256 possible levels (i.e., intensities) for each color component, and 2²⁴=16,777,216 colors overall.

RGB LEDs are known, which provide a selectable color output as an additive combination of R, G and B color components. RGB LEDs may have individual R, G and B control inputs, and a common cathode return signal. Intensity of each color component is controlled by a voltage level on a respective control input. Independently controlling each color component in turn controls the overall color perceived from the RGB LED.

Embodiments in accordance with the present disclosure provide a multimodal status display, which is able to compactly represent a larger number of status conditions than is possible with the conventional art.

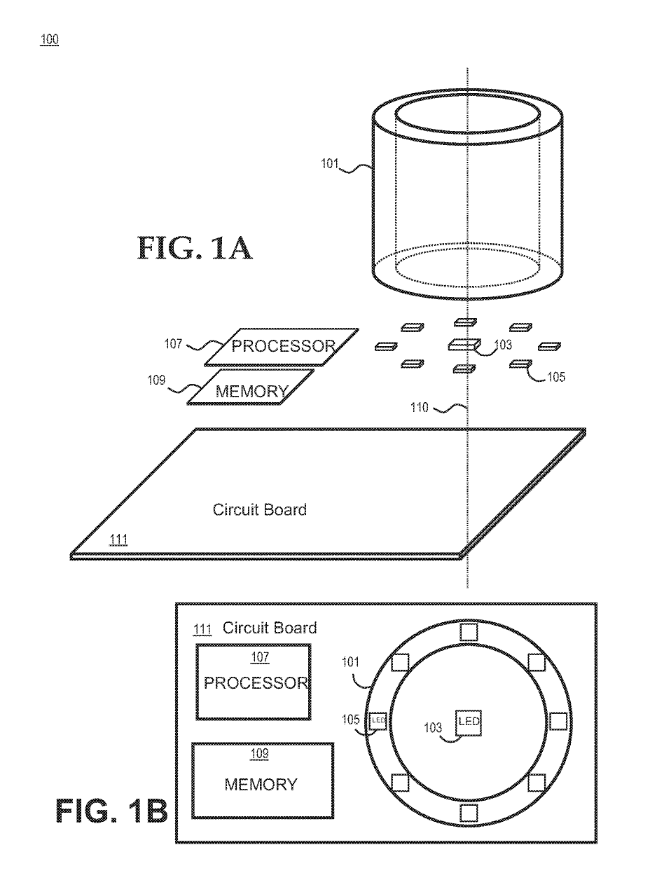

FIG. 1A illustrates an exploded view of a circuit module 100 in accordance with an embodiment of the present disclosure. Circuit module 100 is not drawn to scale, and is simplified to emphasize certain aspects of the embodiment. Well-known or conventional features may be omitted for sake of clarity. FIG. 1A illustrates circuit module 100 exploded along an axis parallel to axis 110. Circuit module 100 includes a circuit board 111, upon which are mounted light sources, e.g., a central light source (e.g., LED 103) and a plurality of spoke light sources (e.g., LEDs 105). Circuit module 100 illustrates eight spoke LEDs 105, but other embodiments may have more or fewer than eight spoke LEDs 105. Each of spoke LEDs 105 may be located at a predetermined distance from central LED 103, and in a predetermined pattern (e.g., in an arc pattern, a grid pattern, a linear pattern, etc.). In some embodiments, spoke LEDs 105 may all be located at a substantially equal distance from central LED 103. In some embodiments, spoke LEDs 105 may be located along an arc, with central LED 103 located at approximately the center of the arc. In some embodiments, spoke LEDs 105 may be equally-spaced along an arc fully encircling central LED 103, and in other embodiments spoke LEDs 105 may be equally-spaced only along an arc that does not fully encircle central LED 103. Central LED 103 and spoke LEDs 105 are configured to emit light principally along an axis parallel to axis 110, perpendicular to and away from circuit board 111. In some embodiments, central LED 103 may produce more lumens of light than a single, individual spoke LED 105. In some embodiments, central LED 103 may produce more lumens of light than spoke LEDs 105 collectively.

Central light source and spoke light sources may include non-LED light sources, such as a miniature incandescent bulb, a miniature gas discharge bulb, a miniature halogen bulb, etc.

Circuit module 100 may further include a processor 107, and a memory 109 coupled to processor 107. Memory 109 may store sets of programmed instructions that, when executed by processor 109, carries out or performs processes and methods in accordance with embodiments of the present disclosure. Circuit board 111 includes electrical connections (not illustrated) to interconnect electrically processor 107, memory 109, central LED 103 and/or spoke LEDs 105. Circuit module 100 may further include a light diffuser 101 mounted over a light-emitting surface of at least spoke LEDs 105. Light diffuser 101 is illustrated as having a cylindrical shape, but other shapes may be used such as a hyperboloid shape, a conical shape, etc.

FIG. 1B illustrates a top plan view of an assembled circuit module 100. Light diffuser 101 is mounted on circuit module 100 such that a solid portion of light diffuser 101 is directly above spoke LEDs 105, and central LED 103 is within or under a central portion of light diffuser 101. Spoke LEDs 105 may be arranged to be substantially mutually coplanar and coplanar with central LED 103. Placement of other elements of circuit module 100 on circuit board 101 are up to a designer's discretion. Light diffuser 101 is constructed from a material that is light-transmissive, e.g., transparent, translucent, or a combination of both. For example, light diffuser 101 may be constructed from a plastic or plastic-type material that is substantially transparent at visible wavelengths along a length (i.e., the height along axis 110) of light diffuser 101. Light diffuser 101 may include design elements that scatter light from spoke LEDs 105, e.g., a surface roughness over at least a portion of light diffuser 101 that allows light to escape due to a local angle of air-surface interface in accordance with Snell's law, or reflective particles embedded or infused within the material of light diffuser 101, etc. Light diffuser 101 diffuses light at least from spoke LEDs 105, and allows the light from spoke LEDs 105 to be visible over a relatively greater range of solid angles with respect to axis 110 (i.e., off-axis directions), and have improved visibility of the spoke LED 105 light at such off-axis directions, compared to the visibility of spoke LEDs 105 without diffuser 101. In some embodiments, diffuser 101 also may improve visibility of light from central LED 103 over a greater solid angle.

Light diffuser 101 is illustrated as being hollow, but in other embodiments may be at least partially filled with a material that is transparent, translucent, or a combination of both. The material over central LED 103 may be the same or different than the material over spoke LEDs 105, and may include design elements that scatter light from central LED 103 (e.g., surface roughness or embedded reflective particles, etc.). A different material may cause light from central LED 103 to be stovepiped out of light diffuser 101 due to differences in indices of refraction, i.e., similar to guided-wave light transmission. In some embodiments, a lens may be placed over central LED 103 in order to spread out light from central LED 103 and further improve diffusion of light.

Circuit module 100 is operated in order to indicate an equipment status, e.g., a status of circuit module 100 itself while processor 107 performs additional functions, or a status of an electronic component, module, etc. communicatively coupled to circuit module 100. For example, processor 107 may be programmed to perform a separate function (e.g., compressing data, verifying data integrity, etc.), and central LED 103 and/or spoke LEDs may be configured to change state based upon the separate function being performed by processor 107. In another example, circuit module 100 may receive status indications from an electronic component external to circuit module 100, and central LED 103 and/or spoke LEDs may be configured to change state based upon the received status indications.

Embodiments in accordance with the present disclosure may indicate status in a multimodal manner, by usage of central LED 103 and/or spoke LEDs 105. “Multimodal” indicates that more than one mode of operation may be used either simultaneously or at different times in order to indicate different status. Modes may include one or more of: a pattern of which of spoke LEDs 105 are lit or not lit; changes to the pattern of which of spoke LEDs 105 are lit or not lit; a color or intensity, or changes thereof, of central LED 103; a color or intensity, or changes thereof, of each of spoke LEDs 105; a time-varying pattern of how central LED 103 and/or spoke LEDs 105 are lit, and so forth. For example, a multimodal status indicator may operate with a first mode of operation being control of a pattern of what spoke LEDs 105 are lit, simultaneously with a second mode of operation being control of what colors of light are emitted from the subset of spoke LEDs 105 that are lit.

For example, with eight conventional LEDs, each LED may indicate one Boolean status, so only eight status indications can be produced. For example, any one such conventional LED may indicate a TRUE state by being lit and a FALSE state by being unlit (or vice versa); or a TRUE state by a steady light and a FALSE state by a blinking light (or vice versa), and so forth. In contrast, if each pattern of a group of eight LEDs indicates a separate status, then eight LEDs can together in combination convey at least 2⁸=256 status indications or indications of operating modes. For example, assuming that eight LEDs are indicated as LED1 through LED8, a first status may be indicated if LED1+LED2 are lit simultaneously, and a second, completely independent status can be indicated by illuminating LED1+LED+LED5+LED7 simultaneously. Whether any one LED is lit (e.g., LED1 in this example) is not sufficient to indicate status, because status is indicated by a combination of multiple LEDs.

Using all available spoke LEDs 105 to form a pattern that indicates one state (i.e., a status) does not allow other states to be indicated at the same time by spoke LEDs 105. In some embodiments, a predetermined number of spoke LEDs 105 may be reserved for a dedicated status (e.g., one spoke LED 105 to indicate a critical error), and the remaining spoke LEDs 105 used to form a smaller number of patterns (e.g., 128 patterns). In other embodiments, additional operating modes of spoke LEDs 105 may be controlled simultaneously in order to indicate additional status information. For example, if spoke LEDs 105 are all RGB LEDs, then LED1+LED2 lit in red may indicate a different status than LED1+LED2 lit in blue. Similarly, other modes may include modulating LED intensity to create a pulsating pattern (e.g., intensity of LED1+LED2 vary in unison), or moving pattern (e.g., one LED from among LED1+LED3+LED5+LED7 is lit in red and the rest of the LEDs from among LED1+LED3+LED5+LED7 are lit in green, and which LED is lit in red cycles among LED1+LED3+LED5+LED7; or an intensity of a single spoke LED 105 may be cycled similarly, etc.), a speed at which the additional mode changes (e.g., a faster pulsation may indicate a more critical status than a slower pulsation), and so forth.

Modulating LED intensity may include adjusting an LED control (e.g., an input voltage or current) in order to produce a time varying pattern that may include two or more non-dark intensity levels of light. Optionally, LED off (i.e., an additional intensity level of “dark” or unlit, etc.) may be used as an additional intensity level during modulation. In some embodiments, the number of intensity levels is a power of two (e.g., 4 levels, 8 levels, 16 levels, 256 levels, etc.). In some embodiments, the total number of intensity levels is limited to no more than a predetermined number of levels (e.g., 4 levels or 8 levels) so that adjacent intensity levels may be sufficiently separated in lumens to be perceivable by a human.

In some embodiments in accordance with the present disclosure, central LED 103 may be used in a multimode manner to indicate a category of operation, and spoke LEDs 105 may indicate a process status, field flags, or the like within the category of operation. For example, central LED 103 lit in green may indicate that a backup operation is taking place, and central LED 103 lit in blue may indicate that a restore operation is taking place. Within the respective process (e.g., backup or restore in this example), spoke LEDs 105 will indicate process status relevant to the process indicated by spoke LEDs 105 (e.g., a speed of pulsation of spoke LEDs 105 may be correlated with speed of data transfer). A field flag may indicate an optional aspect of the category of operation. For example, if the category of operation is a backup, a field flag may indicate if the backup is an incremental backup or a full backup. Field flags may also be more applicable to small-scale operations (e.g., operations at an assembly language level of operation), where field flags may indicate different values in processor registers that would be used to control options of the small-scale operations or to provide parameter values, thresholds, Boolean switches, or the like.

In some embodiments in accordance with the present disclosure, circuit module 100 may be designed to provide an indication of data security of an external electronic component to which circuit module 100 is mated, and from which circuit module 100 should not be disconnected after factory configuration. For example, if circuit module 100 has never been disconnected physically from the external electronic component after factory configuration, then a first operational category may be indicated by a first mode of the multimodal status indicator. However, if circuit module 100 has been disconnected physically from the external electronic component after factory configuration (e.g., by attempted physically theft of equipment or data), then a second operational category may be indicated by a second mode of the multimodal status indicator.

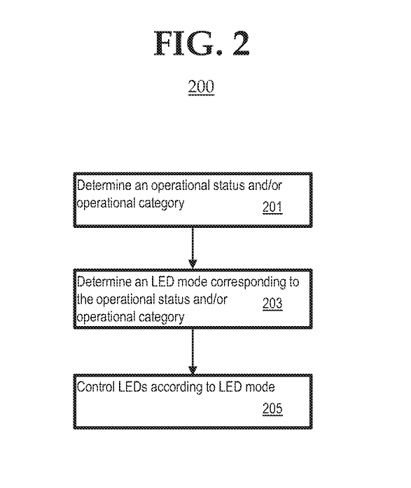

FIG. 2 illustrates a process 200 in accordance with an embodiment of the present disclosure. Process 200 begins at step 201, at which a processor (e.g., processor 107) determines an operational status and/or operational category of a monitored electronic equipment. The operational status may be specific to an operational category. For example, a sensor may provide status, or processor 107 may be informed of status by a message (e.g., an interrupt message), from the monitored electronic equipment. In some embodiments, the sensor may include a software process or daemon, a watchdog timer, or a resource monitor to monitor usage of resources (e.g., CPU cycles, memory utilization, communication bandwidth usage, non-volatile memory usage or access, etc.). In some embodiments, a sensor may include a hardware sensor such as a thermal sensor, etc.

Next, at step 203, processor 107 will determine an LED mode corresponding to the determined operational status and/or operational category. Determination of LED mode may be based upon, e.g., a table lookup of a table stored in memory 109 (e.g., if status “A” is active, then illuminate LED1+LED3+LED5+LED7), or calculation by processor 107 (e.g., calculate a pulsation rate from a data transfer rate), and so forth.

Next, at step 205, processor 107 will drive central LED 103 and/or spoke LEDs 105 to indicate the detected category of operation and/or operational category.

Embodiments of the present disclosure include a system having one or more processing units coupled to one or more memories. The one or more memories may be configured to store software that, when executed by the one or more processing unit, allows practice of embodiments described herein, at least by use of processes described herein, including at least in FIG. 2 and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present disclosure may be dependent on various considerations, such as the speed or efficiency requirements of the system, the particular function, and the particular software or hardware systems being utilized.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the disclosure to the precise form disclosed. Modifications and variations are possible in light of the above teachings or may be acquired from practice of the disclosure. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the disclosure unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112(f), and any claim without the word “means” is not so intended.

1. A multimodal status indicator, comprising:
a processor coupled to a memory;
a sensor coupled to the processor, to provide a status of a monitored equipment;
a central light source coupled to the processor;
a plurality of spoke light sources coupled to the processor; and
a hollow cylindrical light diffuser mounted over a light emitting side of each of the plurality of spoke light sources;
wherein the memory stores sets of programmed instructions that, when executed by the processor, drive an operating mode of the central light source and spoke light sources to indicate the status of the monitored equipment.

2. The multimodal status indicator of claim 1, wherein the operating mode comprises control of a lit and unlit pattern of the spoke light sources.

3. The multimodal status indicator of claim 1, wherein the operating mode comprises control of a pulsating pattern of the spoke light sources.

4. The multimodal status indicator of claim 1, wherein the operating mode comprises control of a combination of colors of the spoke light sources.

5. The multimodal status indicator of claim 1, wherein the central light source indicates a category of operation of the monitored equipment, and the spoke light sources indicate an aspect of the category of operation.

6. The multimodal status indicator of claim 1, wherein the central light source is under a central portion of the light diffuser.

7. The multimodal status indicator of claim 6, wherein the light diffuser comprises a light-transmissive body configured to diffuse light from the spoke light sources over a relatively greater solid angle.

8. The multimodal status indicator of claim 6, wherein the light diffuser comprises embedded reflective particles.

9. The multimodal status indicator of claim 6, wherein an exterior surface of the light diffuser comprises a roughened surface to improve light diffusion.

10. The multimodal status indicator of claim 6, wherein the light diffuser further comprises a portion coupled to the central light source.

11. The multimodal status indicator of claim 10, wherein the portion coupled to the central light source comprises a lens.

12. A method to operate a multimodal status indicator, comprising the steps of:
mounting a hollow cylindrical light diffuser over a light emitting side of each of a plurality of spoke light sources;
sensing a status of a monitored equipment;
determining a first operating mode of a central light source and [[a]] the plurality of spoke light sources to indicate the sensed status of the monitored equipment; and
controlling the central light source and the plurality of spoke light sources in accordance with the determined operating mode.

13. The method of claim 12, wherein the first operating mode comprises a mode selected from a group consisting of control of a lit and unlit pattern of the spoke light sources, control of a pulsating pattern of the spoke light sources, and control of a combination of colors of the spoke light sources.

14. The method of claim 12, further comprising steps of:
determining a second operating mode of a central light source and a plurality of spoke light sources to indicate the sensed status of the monitored equipment; and
controlling the central light source and the plurality of spoke light sources simultaneously in accordance with the first operating mode and the second operating mode.

15. The method of claim 12, further comprising steps of:
indicating a category of operation of the monitored equipment by control of the central light source; and
indicating a process status of the category of operation by control of the spoke light sources.

16. The method of claim 12, wherein the first operating mode comprises an indication of a data security of the monitored equipment.
